(19) United States
(12) Patent Application Publication
(10) Pub. No.: US 2007/0185766 A1
(43) Pub. Date: Aug. 9, 2007

(54) System encouraging website visitors to recommend the site

(75) Inventors: Arik Barel, Jerusalem (IL); Ran Toren, Jerusalem (IL)

Correspondence Address: TIAJOLOFF & KELLY, CHRYSLER BUILDING, 37TH FLOOR, 405 LEXINGTON AVENUE, NEW YORK, NY, 10174, US

(73) Assignee: I.S.E.C. Holdings Ltd., Jerusalem (IL)

(21) Appl. No.: 11/349,442

(22) Filed: Feb. 7, 2006

(51) Int. Cl. G06Q 30/00

(52) U.S. Cl. 705/14

(57) ABSTRACT

A system for encouraging visitors to at least one Website to recommend the site to others by use of bonuses and other rewards to be given to the visitors. The system includes software that is downloaded or otherwise transferred to the Website and a proprietary server that downloads or otherwise transfers the software via the Internet, for example, to customer sites. A method is disclosed for encouraging visitors to the at least one Website to recommend the site to others by use of bonuses and other rewards. The method includes downloading or otherwise transferring of software to the at least one Website for organizing and administering the bonuses and other rewards. The method also includes choosing a method by the management of the at least one Website for rewarding those recommending the site to others and emailing to a friend by a visitor of a recommendation of the at least one Website, such that the software is maintained only at the at least one Website.

### FIELD OF THE INVENTION

The present invention relates to a system for promoting Websites, and more particularly, to a system for encouraging website visitors to recommend the site to others by use of bonuses and other rewards.

### BACKGROUND OF THE INVENTION

In US Pat. Applic. No. 2004059683, An Automated Multi-Level Marketing System, Epstein, et al, describe a method for automated multi-level marketing of an electronic item. The method includes providing a secured electronic item originating from a distributor, and a first user packaging a copy of the secured electronic item with secured payment details for the first user to receive a payment, thereby producing a packaged secured electronic item. Related apparatus and methods are also described.

US Pat. Applic. No. 20040093269, by Rubin, et al, Multi-Level Sales and Marketing Methodology for the Internet, discloses a unified, flexible, extensible, distributed multi-level purchasing, sales and marketing methodology for companies conducting business on the Internet. A Participant in the present invention registers with a Host/Hub and an account is established for the Participant. As Participants perform certain activities such as purchases, surfing or viewing ads with respect to the Host/Hubs and its commercial Partners, the Participants are awarded “credits” that are credited to the Participant's bank accounts. The “credits” in a Participant's account can be used for a variety of purposes such as credits for new purchases, bill payment, micro-payments and cash redemption. Participants are additionally rewarded credits on the basis of the point generating activities performed by each new Participant signed up by the original Participant, and each subsequent Participant signed up by the new participant. This multi-level marketing approach to Internet commerce is accomplished by linking the accounts of the related Participants. As lower level Participants receive credits, a portion of those credits are credited to the account of the higher level Participants.

FIG. 3 of the Rubin, et al, invention depicts the multilevel structure of the revenue (point) sharing by Participants. In addition to receiving credits for making purchases or performing other Qualified Activities themselves directly, Participants receive credits for the Qualified Activities of each subsequent Participant that the original Participant signs up to the system of the present invention. As described above, an unsolicited visitor to the Host/Hub 120, may enroll in the program, establish an Account 340 and receive an ID 305 (FIG. 2) and thus becoming a “Level 1” Participant 360, 370. In order to expand the Participant pool, Level 1 Participants 360, 370 introduce other unknown parties to the Host/Hub 120 (the parties are previously unknown to the Host/Hub 120). The introduction is preferably made via an accountable method such as through an E-mail through the Host/Hub 120 or some other mechanism such that the Host/Hub 120 can verify that the Level 1 Participant 360-370 initiated the introduction. Furthermore, Host/Hub 120 can keep track of the referrals to prohibit someone from registering as a new Participant in order to subvert the multilevel credit sharing of the present invention.

An example of a similar patent pending working system may be found at “Imvite.com.”

FIG. 1 is a Prior art schematic illustration of the Imvite system and method. In order to take advantage of the Imvite method and make money thereby, a first person/user 100 needs to download 110 the Imvite messenger over the Internet 120 from the Imvite server 130. The messenger is software that is similar in most aspects to Yahoo messenger, Microsoft passport, ICQ and a few others.

The difference is that first person/user 100 that already installed the Imvite messenger can, through the messenger, recommend it to others. Imvite also lets first persons/user 100 buy in their virtual mall 160 and get discounts.

If a person/user 100 who downloaded Imvite, recommends the messenger (through the messenger recommendation button 105) to a second person/user 150 and then second person/user 150 downloads the Imvite messenger 140, second person/user 150 is placed under the recommending person/user 100 in the Imvite tree of references. When second person/user 150 buys in Imvite mall 160, the recommending first person/user 100 will gain money or credits.

### SUMMARY OF THE INVENTION

Accordingly, it is a principal object of the present invention to provide software that is not made for its own Website, but for other e-commerce sites, casinos or any other site using Multi-level-martketing (MLM) in order to recruit new customers and increase sales.

It is another principal object of the present invention that a customer will not need to download any software in order to enjoy the benefits of the system and all the calculations regarding the bonuses the customer deserves will be transparent to the customer and according to the policies of the companies that will be using the platform.

It is one other principal object of the present invention that all the assets from the usage of the platform such as emails and actual addresses will belong to the companies that will be using the platform, and not to the software provider, as in the case of Imvite-type systems.

It is a further principal object of the present invention that the inventive Website can work with competing sites because there is no sharing of email lists with others. Each site will create its own data base of customers. By contrast, Imvite uses the same customer data base repeatedly.

It is still another principal object of the present invention to allow different stores to use different kind of discounts, rebates or promotion policies. By contrast, the Imvite system does not allow such flexibility.

It is yet a further principal object of the present invention that the goal of the inventive Website is to promote the sites of its customers. By contrast, it is the goal of Imvite and similar sites to promote their site and their software, i.e., the messenger.

Accordingly, the present invention provides a system for encouraging visitors to at least one Website to recommend the site to others by use of bonuses and other rewards to be given to the visitors. The system includes software that is downloaded or otherwise transferred to the Website and a proprietary server that downloads or otherwise transfers the software via the Internet, for example, to customer sites. A method is disclosed for encouraging visitors to the at least one Website to recommend the site to others by use of bonuses and other rewards. The method includes downloading or otherwise transferring of software to the at least one Website for organizing and administering the bonuses and other rewards. The method also includes choosing a method by the management of the at least one Website for rewarding those recommending the site to others and emailing to a friend by a visitor of a recommendation of the at least one Website, such that the software is maintained only at the at least one Website.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a Prior Art schematic illustration of the Imvite system and method;

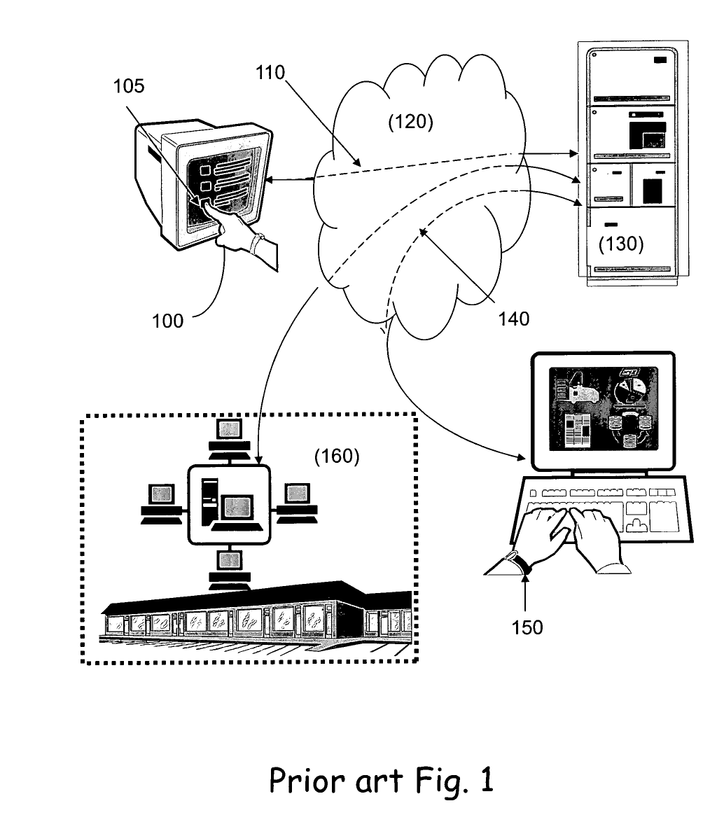

FIG. 2 is a schematic illustration of the system and method, constructed according to the principles of the present invention;

FIG. 3 is a flow chart of an exemplary method, constructed according to the principles of the present invention; and

FIG. 4 is an exemplary organization chart for the rewards that a referring customer Al deserves from online store Y, constructed according to the principles of the present invention.

### DETAILED DESCRIPTION OF AN EXEMPLARY EMBODIMENT

The principles and operation of a method and a system according to the present invention may be better understood with reference to the drawings and the accompanying description, it being understood that these drawings are given for illustrative purposes only and are not meant to be limiting.

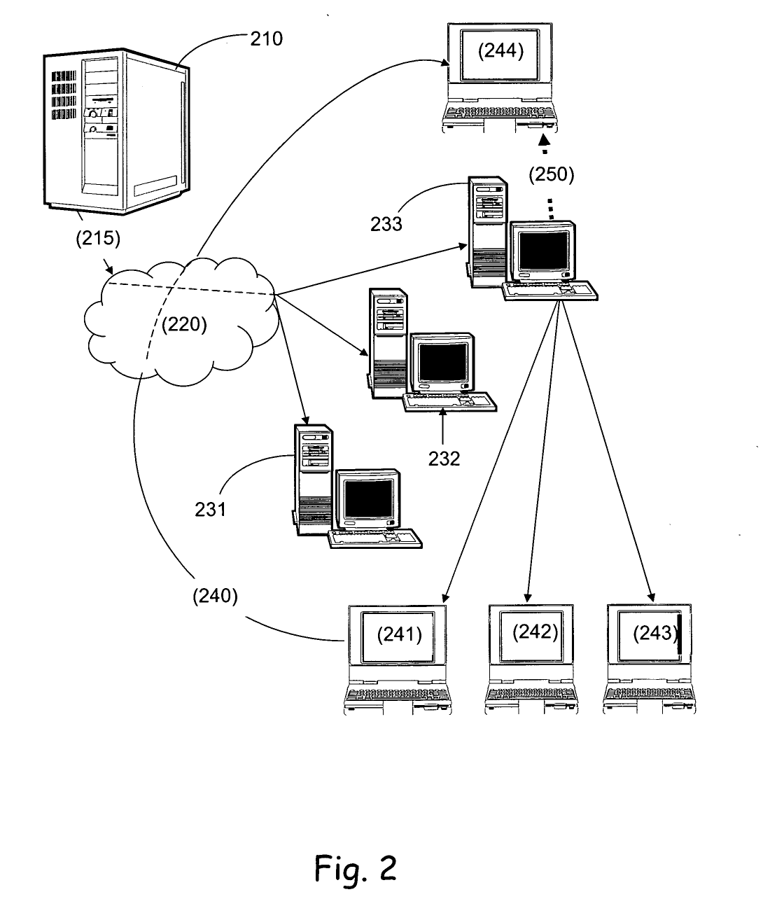

FIG. 2 is a schematic illustration of an exemplary system, constructed according to the principles of the present invention. The present invention is based on providing a site 210 that downloads, or otherwise receives, the software 215 via the Internet 220, or via other means of delivery, to customer sites 231, 232 and 233. These sites then have the ability to run the software on their servers. Customer site 233 is shown to have built its own tree of private customer 241, 242 and 243. Known and regular ways of promoting the customer sites are used and there is no need to ask private customers 241, 242 and 243 to download any software to their computer.

The software is intended to substantially increase the customer sites exposure and customer databases of businesses on the Internet. Such businesses include online retail stores, online casinos, service sites, adult sites and so on. Online retail stores are only discussed as an example. The software is also intended for any online site that wishes to increase its reach.

The software is based on the principles of Multi Level Marketing (MLM) methods, although it is not strictly speaking an MLM method and has significant differences.

With continuing reference to FIG. 2, the software lets private surfer/customer 241, for example, on retail Internet customer site 233, recommend the site to (an)other potential surfers/customer(s) 244, through the use of email(s) 240. In case of conversion, whereby the recommendation has led to a transaction 250, referring private customer 243 will get a reward from store/retail Internet customer site 233.

The software will also let referring customers enjoy the benefits of transactions made not only by customers who were referred directly by them, but also by customers who were referred indirectly by them. E.g., in some cases customers were referred by other people that they themselves were referred by.

Thus, the software can build a virtual tree of references with unlimited levels of referred potential customers under each customer and it will be able to let a customer enjoy benefits from the purchases of all the customers in the chain beneath him. The details of this depends on the policy of the store that uses the software The software allows the store to decide if a referring person can be anyone who is registered on the store's site or, alternatively, only a customer that bought from the store at least once.

The ways retail sites now use to encourage their customers to bring their friends into the site are unlike the method of the present invention, which provides integration with other site's shopping cart software and provides for seamless automation of the whole process. The present invention provides for automatic building of the reference trees. There is no need for the referred customer to add his details, to tell how he arrived at the site or to tell who referred him. The software automatically does the whole process.

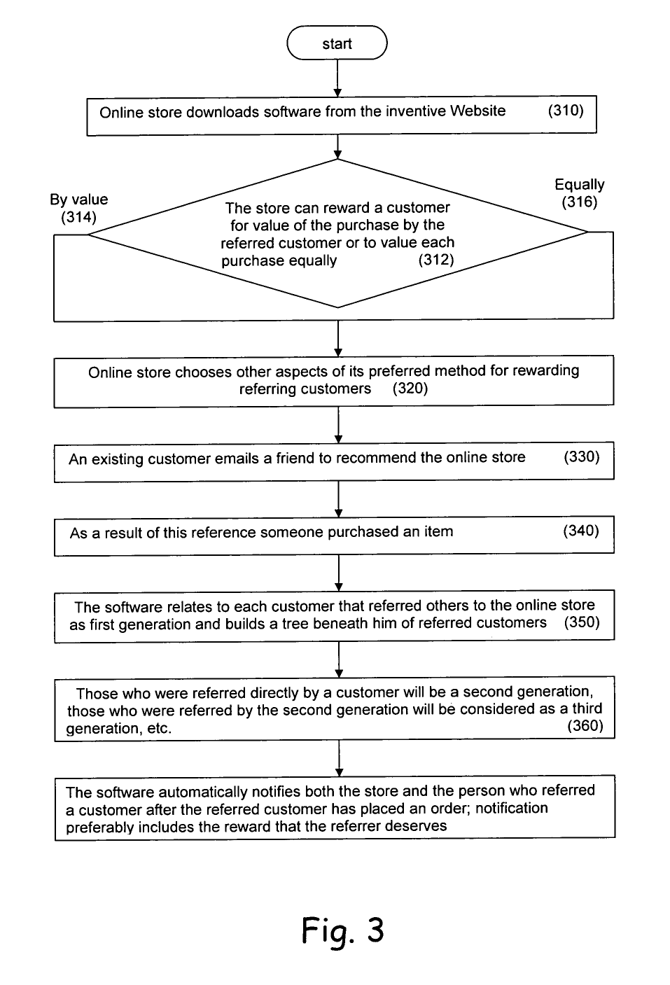

FIG. 3 is a flow chart of an exemplary method, constructed according to the principles of the present invention. The online store downloads software from the inventive Website 310. The store will be able to choose to reward a customer according to the value of the purchase that was made by the referred customer or to value each purchase the same no matter what its value 312. The store will be able to choose to reward a customer according to the value of the purchase that was made by the referred customer 314. The store can alternatively value each purchase equally no matter what its value 316.

The store generally chooses the methods that it prefers to reward referring customers when as a result of their references someone purchased an item 320.

The reward can be cash back to the referring customer, accumulation of points in a store membership club in order to get presents in the future, getting store discounts in the future, getting presents according to the amount purchased by the referred customer, getting a store credit or coupon valid in the online store, and so on.

An existing customer emails a friend to recommend the online store 330. As a result of this reference someone purchased an item 340.

The software will relate to each customer that referred others to the online store as a first generation and will build a tree beneath him of referred customers 350. Those who were referred directly by him will be a second generation, those who were referred by the second generation will be considered as a third generation to the original referrer and so on 360.

The store uses the inventive software to decide on the details of the rewards and their levels. The software will preferably let the store choose if the rewards will be divided between all the generations up to the first, only between a limited number of generations or if the rewards will go only to the person who referred the purchaser directly.

For example, if a reward depends on the value of the purchased made by the referred customer, it is possible to allocate a percentage of the amount of the purchase towards the reward. Then the store will implement the decision of how to divide the rewards. If the total of the reward from each purchase made by a referred customer is 10% of the purchase, for example, the store can decide to divide it between all generations backwards until the “root” referring customers—the first generation. The store can also decide to divide it between a limited number of generations. If it will decide, for example, on four generations it can either give each of the four persons 2.5% of the rewards or decide that the direct referrer gets 4%, his referrer gets 3%, his referrer 2% and his referrer 1%. The total is 10% in either case. The store can also decide that only the direct referrer gets a reward, so in this case he would get the whole 10%.

Today most of the online retail stores include the following features, which are also options for the present invention:

A surfer on the site has the option to register on the site and to get promotions from the site through emails.

The site promotional emails and offers usually include the option of: “send to a friend” link, which lets the person who gets the email click on it and then when a window pops up he puts his name and email address and a friend's name and email and therewith sends a recommendation to his friend about the site. Then the friend gets an email from the person with a link to the special offer.

Many online stores also use the “send to a friend” feature on each page on the site next to their products and special offers.

The software of the present invention is capable of merging with the store software, and for each referral made by the “send to a friend link,” the software will take the referring and the referred customers and put them under a “virtual tree” of references. By doing so the software will know how to relate each buying customer to his referrer, if one exists, and the software will be able to reward the referrer according to the online store policy.

With continuing reference to FIG. 3, the software will automatically notify both the store using it and the person who referred a customer after the referred customer has placed an order. The notification will also include the reward that the referrer deserves 370.

The proprietary software of the present invention will be associated with servers, such as server 210 in FIG. 2, that will get details from the stores' servers 231, 232 and 233 that are using the software and for every order it will calculate online whether it came from a referred customer who deserves a reward and what is the reward.

The revenue of the proprietorship associated with the present invention would generate from the amount of sales derived from the software by the using store.

For example, store X may get a total of $1,000 during the month of mm/2006 from referred customers. The agreement between said proprietorship and store X is that the proprietorship should get 1% off the sales that come through referred customers. So in this case the proprietorship should get a total of $10 for the month of mm/2006.

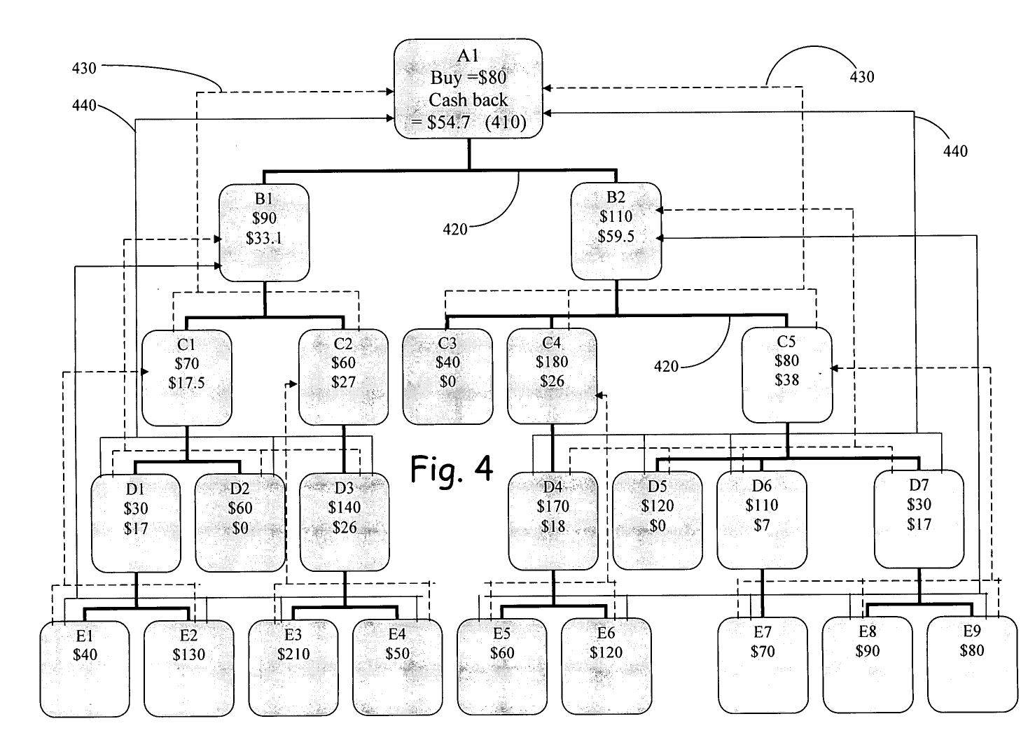

FIG. 4 is an exemplary organization chart for the rewards that a referring customer A1 deserves from online store Y 410, constructed according to the principles of the present invention. The example is presented in FIG. 4 in order to better understand the mechanism of the reward calculation software.

Company Y policy:
The rewards would be in the form of cash back to the bank account of the referring customer.
The referring customer will benefit only from purchases made by the three generations below him.
The total rewards from a purchase that was made by a referred customer will be 10%
The referring customer (the first generation) will enjoy 5% cash back from purchases made by the second generation, 3% from purchases from the third generation and 2% from purchases made by purchases of the fourth generation of referred customers beneath him. The company has decided that the customer benefit only from three generation of referred customers.

FIG. 4 shows the referrals made by customer A1, the second, third and fourth generations beneath him refers and purchases, and customer A1 rewards.

The heavy lines 420 show connections between first and second generations and in the case of purchase rewards the first generation with 5% cash back.

The dotted lines 430 show connections between first and second generations and in case of purchase rewards the first generation with 3% cash back.

The light lines show connections between first and second generations and in case of purchase rewards the first generation with 2% cash back.

In each box the top row indicates the customer name, the second row the amount of purchase in the store that hem made, and the third row shows the cash back amount that the customer deserves from the purchases of the customers he referred.

It is to be understood that the phraseology and terminology employed herein are for the purpose of description, and should not be regarded as limiting.

It is important, therefore, that the scope of the invention is not construed as being limited by the illustrative embodiments set forth herein. Other variations are possible within the scope of the present invention as defined in the appended claims and their equivalents.

We claim:

1. A system for encouraging visitors to at least one Website to recommend the site to others by use of bonuses and rewards to be given to those doing the recommending, the system comprising:
software that is transferred to the Website; and
a proprietary server that provides for delivery of said software to customer sites,
such that said software is maintained at the at least one Website.

2. The system of claim 1, wherein the transferring is provided by downloading via the Internet.

3. The system of claim 1, wherein the at least one Website is part of an online mall.

4. The system of claim 1, wherein the at least one Website is an online retail stores.

5. The system of claim 1, wherein the at least one Website is an online casinos.

6. The system of claim 1, wherein the at least one Website is a service site.

7. The system of claim 1, wherein the rewards are based on a multi-level marketing (MLM) method.

8. The system of claim 1, wherein the rewards are rebates.

9. The system of claim 1, wherein the rewards are discounts.

10. The system of claim 1, wherein the email addresses of the recommending visitors and of those who they recommend remain in sole possession of each of the at least one Websites.

11. The system of claim 1, wherein the software automatically notifies both the at least one Website and the recommending visitor after the one receiving recommendation has placed an order.

12. The system of claim 11, wherein the notification further comprises the reward that the rerecommending visitor deserves.

13. The system of claim 1, wherein said software provides that each of the at least one Websites determines the form of the rewards and bonuses.

14. A method for encouraging visitors to at least one Website to recommend the site to others by use of bonuses and rewards to be given to those doing the recommending, the method comprising:
transferring software to the at least one Website for organizing and administering the bonuses and rewards;
choosing a method by the management of the at least one Website for rewarding those recommending the site to others;
emailing to a friend by a visitor of a recommendation of the at least one Website,
such that said software is maintained at the at least one Website.

15. The method of claim 14, wherein the rewards are based on a multi-level marketing (MLM) method.

16. The method of claim 14, wherein the transferring is provided by downloading.
